(19) United States
(12) Patent Application Publication
(10) Pub. No.: US 2010/0273041 A1
(43) Pub. Date: Oct. 28, 2010

(54) TEMPERATURE MANAGEMENT SYSTEM

(75) Inventors: JENNIFER P. LAWALL, Waterford, MI (US); HANS P. LAWALL, Waterford, MI (US); STEVEN E. MORRIS, Fair Haven, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/429,521

(22) Filed: Apr. 24, 2009

(51) Int. Cl. H01M 10/50

(52) U.S. Cl. 429/120

(57) ABSTRACT

A system for managing the temperature of a battery, the battery having a first outer surface, is provided. The system comprises a first reservoir coupled to the first outer surface of the battery, and a first phase change material thermally coupled with the first outer surface of the battery, and retained by the first reservoir.

### TECHNICAL FIELD

The present invention generally relates to batteries, and more particularly relates to a system for managing the temperature of a battery.

### BACKGROUND OF THE INVENTION

In recent years, advances in technology have led to substantial changes in the design of automobiles. One of these changes involves the complexity, as well as the power usage, of various electrical systems within automobiles, particularly alternative fuel vehicles. For example, alternative fuel vehicles such as hybrid vehicles often use electrochemical power sources, such as batteries, ultracapacitors, and fuel cells, to power the electric traction machines (including electric motors and motor/generators) that drive the wheels, sometimes in addition to another power source, such as an internal combustion (IC) engine.

Many hybrid vehicles are equipped with an extensive array of rechargeable batteries such as, for example, lithium-ion batteries, that are designed for years of use and have enough storage capacity to power a vehicle long distances between recharging. It is well known that the operating environment of a battery can appreciably affect its output efficiency and lifespan. For example, batteries generate more power per recharge and have a greater lifespan when used within a moderate range of temperatures. When exposed to sub-optimal temperatures, battery efficiency is reduced, potentially reducing the number of miles that can be driven between recharges and requiring more fuel to be consumed. Conversely, prolonged exposure to temperatures above an optimal range can shorten battery life. Maintaining batteries within a moderate temperature range, therefore, can further increase the overall cost benefit of driving a hybrid or electric vehicle.

Accordingly, it is desirable to provide a temperature management system for a battery. Further, it is also desirable if such a system provides temperature management in both hot and cold ambient conditions. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

In accordance with an embodiment, by way of example only, a system is provided for managing the temperature in a battery, the battery having an outer surface. The system comprises a first reservoir coupled to the first outer surface of the battery, and a first phase change material thermally coupled with the first outer surface of the battery, and retained by the first reservoir.

In accordance with another embodiment a battery is provided. The battery comprises an outer wall and a first phase change material encapsulated within the outer wall.

### DESCRIPTION OF THE DRAWINGS

A more complete understanding of the present invention may be derived by referring to the detailed description and claims when considered in conjunction with the following figures, wherein like reference numbers refer to similar elements throughout the figures, and

FIG. 1 is a schematic diagram of an exemplary vehicle illustrating the manner in which an embodiment is integrated with various sub-components of the vehicle;

FIG. 2 is an isometric view of an exemplary battery for use with the vehicle depicted in FIG. 1, and having an integrated temperature management system in accordance with an exemplary embodiment;

FIG. 3 is an isometric view of the battery illustrated in FIG. 2, having an integrated temperature management system in accordance with another exemplary embodiment;

FIG. 4 is a schematic diagram illustrating in cross-section the battery depicted in FIGS. 2 and 3, and having a temperature management system in accordance with another exemplary embodiment;

FIG. 5 is a schematic diagram illustrating in cross-section, a battery suitable for deployment in the vehicle shown in FIG. 1, and having a temperature management system in accordance with another exemplary embodiment;

FIG. 6 is an isometric view of a battery assembly suitable for any of the batteries depicted in FIGS. 2-5, and having a temperature management system in accordance with another exemplary embodiment;

FIGS. 7A and 7B are schematic diagrams illustrating a temperature management system in accordance with yet another exemplary embodiment;

FIG. 8 is a schematic diagram illustrating a temperature management system in accordance with yet a further exemplary embodiment;

FIG. 9 is a graph illustrating a temperature profile for a PCM layer of the types used with any one of the embodiments illustrated in FIGS. 2-8, in accordance with another exemplary embodiment; and

FIG. 10 is a block diagram illustrating a supplementary thermal system useful for controlling temperature within a PCM-comprising layer of the types illustrated in FIGS. 2-8, in accordance with another exemplary embodiment.

### DESCRIPTION OF AN EXEMPLARY EMBODIMENT

The various embodiments of the present invention described herein provide temperature management systems for a battery of the type suitable for deployment in a vehicle. These systems includes a reservoir coupled to the outer surface of the battery, and a phase change material (PCM) retained by the reservoir and in thermal communication with the battery's outer surface. The PCM has an appreciable latent heat of fusion and is formulated to have a constant melting temperature (Tₘ) within the desired operating temperature range of the battery. Depending upon ambient temperatures and/or temperatures within the battery, the PCM absorbs heat from, or releases heat to the battery as needed at a substantially constant melting temperature, Tₘ, to provide the battery with improved temperature stability, maintaining it for longer periods of time within its optimal operating temperature range. The reservoir may be configured to retain the PCM in bulk, or as an encapsulation. Where an encapsulation reservoir is used, the distance between the PCM reservoir and the outer surface of a battery may be adjusted as a function of temperature using shape memory materials. In other embodiments, the PCM may be encapsulated within the outer wall of the battery itself, and/or within the wall of an accompanying battery compartment. In further embodiments, the temperature management system is supplemented by an additional thermal system that adds heat to or removes heat from the PCM as needed to further enhance temperature stability in the battery.

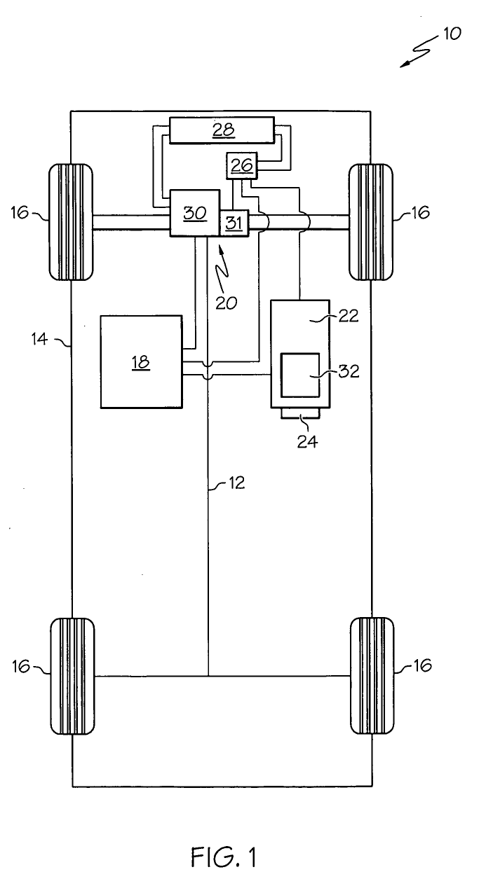

FIG. 1 is a schematic diagram illustrating a vehicle, such as an automobile, 10 according to one embodiment of the present invention. The automobile 10 includes a chassis 12, a body 14, four wheels 16, and an electronic control system (or electronic control unit (ECU)) 18. The body 14 is arranged on the chassis 12 and substantially encloses the other components of the automobile 10. The body 14 and the chassis 12 may jointly form a frame. The wheels 16 are each rotationally coupled to the chassis 12 near a respective corner of the body 14.

The automobile 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD), or all-wheel drive (AWD). The automobile 10 may also incorporate any one of, or combination of, a number of different types of engines (or actuators), such as, for example, a gasoline or diesel fueled IC engine, a “flex fuel vehicle” (FFV) engine (i.e., using a mixture of gasoline and alcohol), a gaseous compound (e.g., hydrogen and/or natural gas) fueled engine, or a fuel cell, a combustion/electric motor/generator hybrid engine, and an electric motor.

In the exemplary embodiment illustrated in FIG. 1, the automobile 10 is a hybrid vehicle, and further includes an actuator assembly (or powertrain) 20, a battery assembly 22, a battery state of charge (SOC) system 24, a power electronics bay (PEB) 26, and a radiator 28. The actuator assembly 20 includes an IC engine 30 and an electric motor/generator (or traction motor/generator) system (or assembly) 31. Battery assembly 22 is electrically coupled to PEB 26 and may include any number of individual batteries of any type. In one embodiment, battery assembly 22 comprises at least one rechargeable lithium ion (Li-ion) battery 32 including a plurality of internal cells, as is commonly used. Assembly 22 includes a temperature management system for at least battery 32, and may also include such a system integrated with the compartment structure for housing battery 32. As will be described in detail below, the temperature management system acts as a heat sink able to absorb and release energy as needed at a substantially constant temperature to stabilize components of assembly 22 including battery 32 within a temperature range more suited to optimal battery performance and longer lifespan.

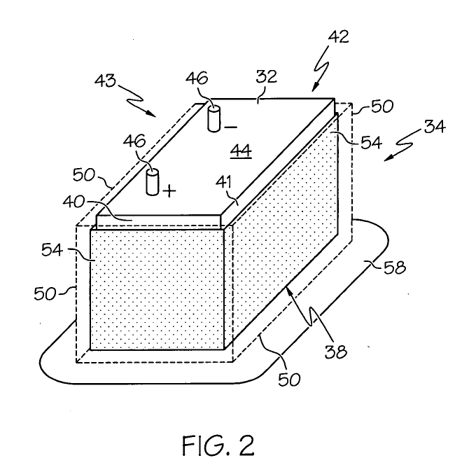

FIG. 2 is an isometric view depicting battery 32 having a temperature management system 34, in accordance with a first exemplary embodiment. Battery 32 assumes the form of a right rectangular prism, and includes a rectangular bottom panel 38, four side panels 40-43, and a top panel 44, each panel having edges interconnected together in a conventional manner to form a secure, sealed structure suitable for internal containment of individual electrolytic cells and an associated electrolyte. Panels for battery 32 are typically constructed from an electrically insulating, durable, and chemically inert material such as, for example, polypropylene, or another suitable thermoplastic material. Any of the side/top/bottom panels of battery 32 may be specifically configured to include contours and/or openings such as for terminals 46, electrolyte filling ports, and the like. While FIG. 2 illustrates battery 32 as a right rectangular prism, it should be understood that other shapes may be used without limitation depending on spatial constraints and overall design considerations. Temperature management system 34 includes a reservoir in the form of a retention jacket 50 coupled to battery 32 and surrounding at least a portion of the outer surfaces thereof, and a PCM layer 54 comprising a suitable PCM retained in bulk between jacket 50 and the outer surface of battery 32. Jacket 50 also includes a bottom panel 58 that may assume any shape such as, for example, that of a tray that extends beyond bottom panel 38 (as shown). While FIG. 2 shows jacket 50 surrounding each of bottom panel 38 and side panels 40-43, it should be understood that jacket 50 may include any number of sections configured to accommodate one or more panels of battery 32 including top panel 44, or any portion thereof in accordance with any desired design. Jacket 50 is sealed in any conventional manner to prevent leakage of PCM layer 54, and is separated from battery panels by any suitable distance to create a volume therebetween for bulk retention of the PCM. Accordingly, PCM layer 54 is in thermal communication with any of the battery panels covered by layer 54.

During operation of battery 32, heat may flow into PCM layer 54 within jacket 50 either from within battery 32 or from its external surroundings. When the temperature of PCM layer 54 rises to Tₘ, layer 54 changes from a solid phase to a liquid phase absorbing heat at a substantially constant temperature Tₘ during this phase change. When the battery and/or the surroundings cool to below Tₘ, heat stored within PCM layer 54 is released into battery 32 substantially at Tₘ until PCM layer 54 has completely solidified. Therefore, during either heating or cooling cycles, battery 32 receives a temperature stabilizing influence via its thermal coupling to layer 54.

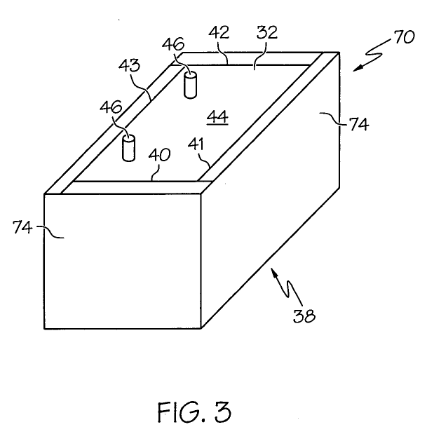

FIG. 3 is an isometric view depicting battery 32 having a temperature management system 70, in accordance with another exemplary embodiment. Battery 32 is configured in the manner described above and illustrated in FIG. 2, having side panels 40-43 and bottom and top panels 38 and 44, respectively. Terminals 46 may protrude through any suitable outer panel of battery 32 such as, for example, through top panel 44 as shown. Temperature management system 70 includes a reservoir for retaining a PCM that assumes the form of a retention layer 74 thermally coupled with side panels 40-43. Ideally, the composition and structure of retention layer 74 is chosen to be compatible for encapsulating the particular PCM chosen. For example, in one embodiment, layer 74 may comprise any material suitable for heterogeneous encapsulation of a PCM, such as, for example having a porous structure that includes a multitude of substantially uniformly distributed voids. Alternatively, layer 74 may comprise a suitable PCM material suspended as a separate phase within a retaining material. In another embodiment, layer 74 may comprise any material suitable for homogeneous encapsulation of a PCM, thereby retaining the PCM as a dissolved solute. Retention layer 74 may assume any overall form such as, for example, that of a rigid or semi-rigid pad, or that of a flexible or cloth-like fabric material. While FIG. 3 illustrates retention layer 74 disposed on each side panel of battery 32, it is understood that layer 74 may be similarly disposed on any side/top/bottom panel, or on any portion of any such panel. Retention layer 74 resides either in physical contact with, or proximate to any battery panels it is disposed on, and is thereby thermally coupled along with the encapsulated or intermixed PCM, to these panels. During heating or cooling cycles, the retained PCM provides temperature stabilization to battery 32 in a manner described above.

The material chosen as the PCM for the various embodiments of this invention may be any suitable material or mixture of materials that undergoes a substantially latent phase transition (at a substantially constant melt temperature, Tₘ) from solid-to-liquid or from liquid-to-solid phases. Ideally, the PCM is formulated so as to have a Tₘ that resides within a known optimal operating range for the associated battery. Suitable PCMs may comprise crystalline alkyl hydrocarbons, paraffins, salt hydrates, poly-alcohols, or any combination of these. The PCM may also comprise a eutectic composition comprising a mixture of more than one material having a substantially constant melt temperature. The PCM ideally has a relatively high latent heat of fusion, and thus may provide significant heat storage capacity per unit volume. As described above, a suitable reservoir may be a structure configured to retain a PCM in any manner including in bulk or as an encapsulation. As used herein, the term “encapsulate” or “encapsulation” as applied to a PCM includes any type of heterogeneous microencapsulation or macroencapsulation wherein particles or regions of a PCM are retained as a separate phase within a retention reservoir layer which may have an accommodative voided or porous structure. These terms also include any type of homogeneous encapsulation wherein a PCM material is dissolved within another retentive material configured to provide structure for retaining the dissolved PCM. Thus, the reservoir may assume the form of either a jacket suitable for retaining a bulk PCM, or a layer suited for encapsulation. Materials suitable as retention reservoirs include but are not limited to polymeric compounds such as, for example, polyethylene, polypropylene, and acrylonitrile butadiene styrene (ABS).

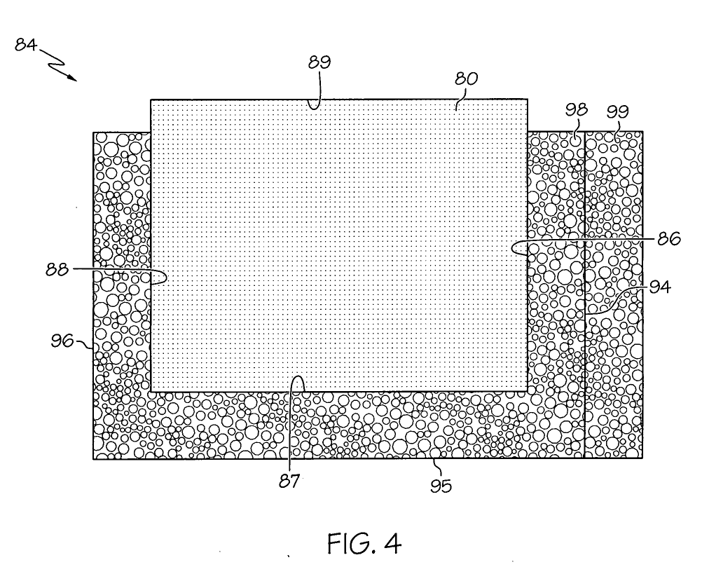

FIG. 4 is a schematic diagram illustrating in cross-section a battery 80 having a temperature management system 84, in accordance with an exemplary embodiment. Battery 80 is configured in a manner previously described with reference to battery 32 and illustrated in FIGS. 2 and 3, and includes an outer housing having side panels 86 and 88, and bottom and top panels 87 and 89, respectively, merged together to form a sealed container. Temperature management system 84 includes retention reservoir layers 94, 95, and 96 in proximity with, and thermally coupled to panels 86, 87, and 88, respectively. Each retention reservoir layer includes a multitude of voids 98 that may have any suitable distribution of sizes or shapes, having any spatial density (number of voids per unit volume of retention layer) configured to encapsulate a PCM therewithin. While FIG. 4 depicts only panels 86-88 of battery 80 as having a retention reservoir layer proximate thereto, it is understood that any battery panel or any portion thereof may have a reservoir layer residing on it. Further, reservoir layers may assume any form such as individual substantially planar pads conformal to the shape of battery panels, or as a continuous flexible material such as a cloth-like material having a structure suitable for retaining a PCM.

In yet another embodiment illustrated in FIG. 4, at least one battery panel has at least one additional retention reservoir layer 99 adjacent any of layers 94-96. Retention reservoir layer 99 may be configured as either a jacket-type reservoir for bulk PCM retention, or as an encapsulation-type reservoir layer having either a dissolved PCM or PCM micro or macroencapsulated within a porous structure (as shown). Retention layer 99 and the PCM retained therein are each thermally coupled to the adjacent retention layer 94, and thus to battery 80 as well. Retention layer 99 may retain a PCM of any of the types described above, but retains a PCM of a different composition and having a different Tₘ from the material retained by layer 94. Such a configuration may provide battery 80 with improved temperature stability by absorbing heat in a latent manner at two different melting temperatures. Those of skill in the art will appreciate that additional layers may be added adjacent and thermally coupled to layer 99, each additional layer having a PCM of any desired composition and Tₘ to provide further temperature stability to battery 80.

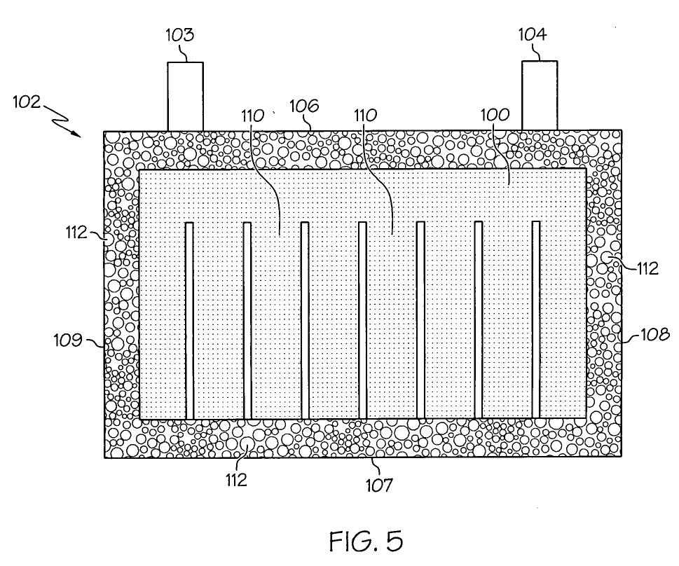

FIG. 5 is a schematic diagram illustrating, in cross-section, a battery 100 having an integrated temperature management system 102, in accordance with another exemplary embodiment. Battery 100 includes positive and negative terminals 103 and 104, and top, bottom, and side outer walls 106-109, each outer wall merged together to form a container suitable for any number of electrolytic cells 110 and an associated electrolyte. While battery 100 as shown in FIG. 5 is formed in the shape of a right rectangular prism, it is understood that any suitable shape may be used such as, for example, that of a cylinder. Outer walls 106-109 are each made from a durable and chemically inert material suitable for housing a battery, such as, for example, polypropylene. Outer walls 106-109 are each configured to encapsulate a PCM, and thus may have either a structure that includes suitable voids 112 (as shown), and/or a composition suitable for retaining the PCM in a dissolved state. During operation, the temperature inside or outside of battery 100 may pass through the Tₘ of the encapsulated PCM. The PCM absorbs heat when the temperature exceeds Tₘ, or releases stored heat at temperatures below Tₘ by changing phase in a manner previously described, providing improved temperature stability to the interior of battery 100, including electrolytic cells 110.

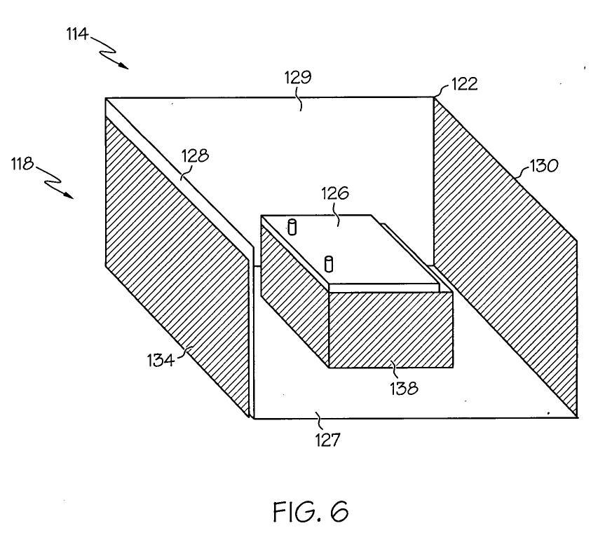

FIG. 6 is an isometric view of a battery assembly 114 having a temperature management system 118, in accordance with another exemplary embodiment. Battery assembly 114 includes a compartment (or housing) 122 configured to contain a battery 126, and having any number of outer walls merged together to provide an enclosure therefor. As shown in FIG. 6, housing 122 includes a bottom outer wall 127 and side outer walls 128-130, while other side and top outer walls have been removed for greater clarity. Battery 126 is conventionally configured as described previously with reference to, for example, battery 32 illustrated in FIG. 2, having rectangular top, bottom, and four side panels. Outer side wall 128 includes a reservoir layer 134 disposed thereon configured to retain a PCM. In one embodiment, reservoir layer 134 assumes the form of a jacket coupled to outer side wall 128, and separated therefrom to form a space for bulk retention of a PCM disposed therein. In another embodiment, reservoir layer 134 assumes the form of a layer suitable for encapsulating a PCM either as a dissolved solute or within a porous structure. In either of these embodiments, reservoir layer 134 and the retained PCM are each in thermal communication with outer side wall 128. Battery 126 may optionally have a temperature management system 138 comprising any of the types previously described pertinent to individual batteries.

Referring to FIG. 6, in another embodiment, outer sidewall 130 is itself configured for and contains an encapsulated PCM. Accordingly, sidewall 130 may be made from a highly voided, porous material or may have a composition suitable for retaining a PCM in a dissolved state as previously described with reference to the outer walls of battery 100, and illustrated in FIG. 5. During operation, the ambient temperature inside or outside of housing 122 may rise or fall through the Tₘ of the associated PCM. When the ambient temperature reaches or exceeds Tₘ, the retained PCM absorbs heat at the substantially constant Tₘ of the PCM. Conversely, when ambient temperature reaches or falls below Tₘ, the PCM releases heat to housing 122. Accordingly, such absorption or release of heat at a substantially constant temperature provides temperature stabilization to battery assembly 114 and thus also to battery 126 housed therein. In another embodiment, battery 126 includes at least one PCM-comprising layer 138 which may assume the form of an outer wall or retention layer suitable for retaining a PCM in bulk or as an encapsulation, as previously described.

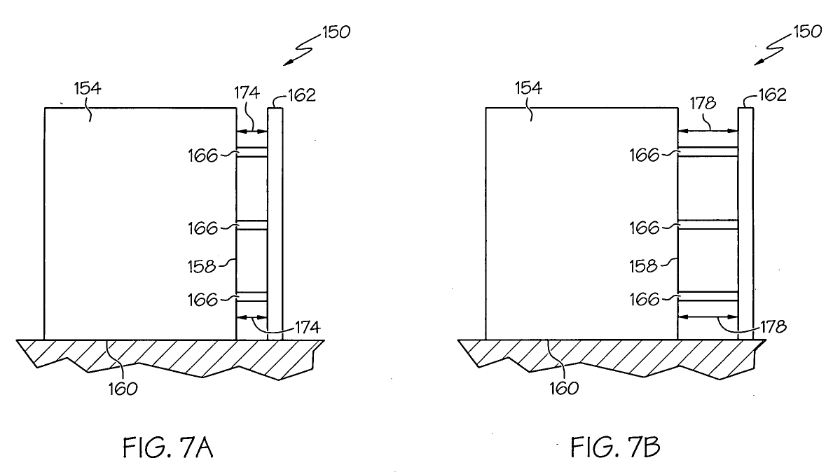

FIGS. 7A and 7B are schematic diagrams of a temperature management system 150 for a battery 154, in accordance with another exemplary embodiment. Battery 154 has any conventional configuration and includes an outer surface 158, and fixedly resides in a compartment 160. Temperature management system 150 includes a PCM layer 162 and at least one shape memory element 166 coupled between layer 162 and battery outer surface 158. PCM layer 162 may be structured as a jacket or as an encapsulation layer of any of the types previously described, and is configured to retain a suitable PCM. Shape memory element 166 is made from a suitable shape memory polymer configured to change volume, expanding and contracting its outer dimensions as a function of ambient temperature. FIG. 7A illustrates a first scenario wherein shape memory element 166 is in a contracted state (due to a lower ambient temperature) and maintains PCM layer 162 at a first gap (represented by double-headed arrows 174) from outer surface 158. FIG. 7B illustrates a second scenario wherein element 166 is in a more expanded state (due to a higher ambient temperature), and moves PCM layer 162 further from outer surface 158, to a second gap (represented by double headed arrows 178) greater than first gap 174. System 150 may be used as a convenient way to change the distance between PCM layer 162 and outer surface 158 to allow more or less air flow therebetween. For example, at higher ambient temperatures, the gap between PCM layer 162 and outer surface 158 may be increased (such as shown in FIG. 7B) to move these elements farther apart enabling greater air flow therebetween and helping to prevent battery 154 from rising above its optimal temperature range. At lower ambient temperatures, the gap may be reduced (such as shown in FIG. 7A) to enable greater heat exchange between outer surface 158 and PCM layer 162.

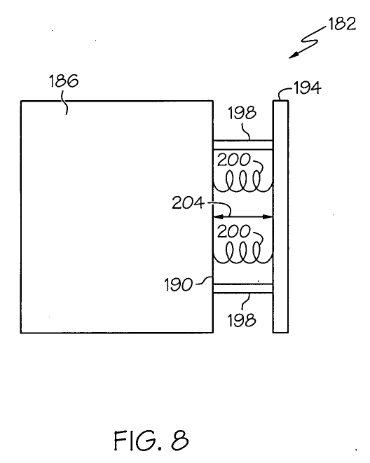

FIG. 8 is a schematic diagram illustrating a temperature management system 182 for a battery 186, in accordance with another exemplary embodiment. Battery 186 has any conventional configuration, and includes an outer surface 190. System 182 includes a PCM layer 194, at least one memory element 198, and at least one resilient member 200. PCM layer 194 comprises a retained PCM either in bulk or as an encapsulation as previously described, and is coupled to battery outer surface 190 by memory element 198 which comprises a suitable shape memory alloy. Memory element 198 may assume any form such as, for example, that of a cord or wire that changes dimension, expanding or contracting in length as a function of temperature in a known manner. Resilient member 200 may be a spring or other similar device configured to generate a resilient force when expanded or contracted beyond an equilibrium length.

During operation, depending upon the ambient temperature, memory element 198 may expand to a slackened, elongated state wherein the distance between outer surface 190 and PCM layer 194 (represented by double-headed arrows 204) is determined by the equilibrium length of resilient member 200. When ambient temperatures cool, memory element 198 may contract pulling outer surface 190 and PCM layer 194 closer together against the resilient force of resilient member 200. This distance may be varied as a means of inducing or restricting air flow between outer surface 190 and PCM layer 194 as previously described. While FIG. 8 illustrates system 182 having a particular arrangement between PCM layer 194, outer surface 190, memory element 198, and resilient member 200, those of skill in the art will appreciate that any number of configurations are possible for adjusting the distance between outer surface 190 and PCM layer 194 using a shape memory alloy element in conjunction with resilient force.

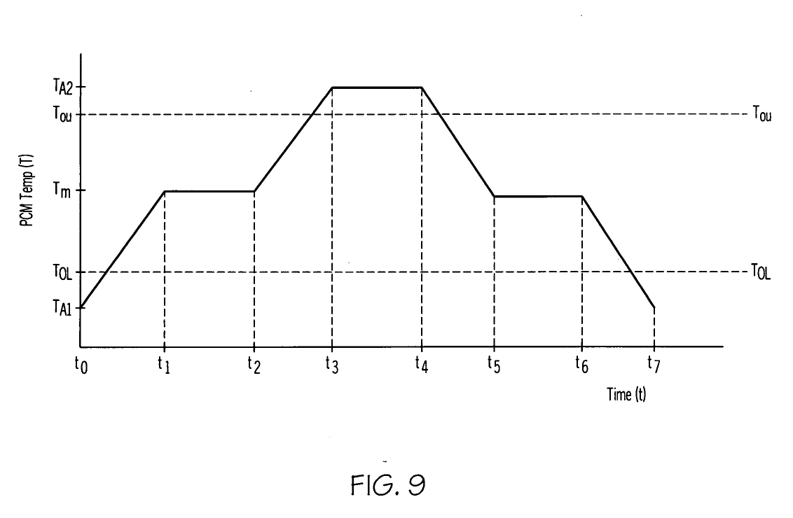

FIG. 9 is a graph illustrating a temperature profile for a PCM comprising layer of the types used with any one of the embodiments previously described, and illustrated in FIGS. 2-8. This profile results from subjecting the PCM-comprising layer to a particular thermal history to be described below. The associated PCM has a melting temperature Tₘ residing between lower and upper optimal operating temperature limits, T_{OL} and T_{OU}, respectively, for an associated battery. The thermal history begins at time t=0 (t₀), prior to which the battery and PCM layer have been immersed in, and have reached equilibrium with, a first ambient temperature (T_{A1}) below T_{OL}. At T_{OL}, the PCM exists as a completely solid phase. At t₀, the temperature of the surroundings rises to a temperature T_{A2} as a result of, for example, the onset of operation of an adjacent IC engine. Between to and t₁, heat flows into and is sensibly absorbed by the PCM, which increases in temperature until Tₘ is reached at t₁. At t₁, the PCM begins a solid-to-liquid phase transformation, absorbing heat between t₁ and t₂ in a latent manner, and changing phase at a substantially constant temperature of Tₘ. At t₂, the transformation to a liquid phase is complete, and the PCM exists in a 100% liquid state at a temperature of Tₘ. The PCM sensibly absorbs heat between t₂ and t₃, rising in temperature until T_{A2} is reached at t₃. Between t₃ and t₄, the PCM may remain at T_{A2} indefinitely, having equilibrated at this upper ambient temperature.

At t₄, the temperature of the ambient surroundings returns to T_{A1} and the PCM begins cooling because, for example, the IC engine is switched off. Between t₄ and t₅, the PCM loses heat sensibly, reaching Tₘ at t₅. At t₅, the PCM begins a phase transformation from liquid to solid, releasing stored energy in a substantially latent manner at Tₘ between t₅ and t₆. At least a portion of the latent heat released between t₅ and t₆ is absorbed into the battery to help maintain an optimal temperature range. At t₆, the PCM has completely solidified, and sensible cooling continues until the equilibrium ambient temperature T_{A1} is reached at t₇. Those of skill in the art will appreciate that the actual time lapse between various temperature milestones will depend upon factors that include the composition and amount of PCM used. For example, additional PCM-comprising layers having the same or different compositions and/or melting temperatures may be used as desired to alter the duration of time that the associated battery is maintained within its optimal temperature range for a given set of ambient conditions. Further, while a linear relationship between time and temperature for sensible heating and cooling is shown in FIG. 9, this is intended only as an example. Those of skill in the art will appreciate that sensible heating and cooling rates are typically non-linear and will depend upon factors that include the conductive and convective heat transfer characteristics of the system.

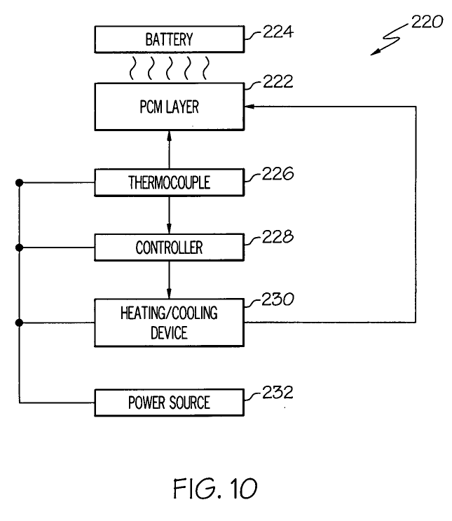

FIG. 10 is a block diagram illustrating a supplementary thermal system 220 useful for controlling temperature within a PCM-comprising layer 222, in accordance with another exemplary embodiment. PCM layer 222 comprises a suitable PCM in either bulk form or as an encapsulation within a retention layer, and resides in thermal communication with a battery 224. Thermal system 220 includes a controller 228 operatively coupled to a temperature sensor 226 and a heating/cooling device 230. Temperature sensor 226 may be any type of temperature detecting device such as, for example, a thermister or a thermocouple, or the like, and is configured to sense the temperature of PCM layer 222 and relay this data to controller 228. Controller 228 is coupled in one-way communication with heating/cooling device 230, and uses temperature data received from sensor 226 to activate device 230 as needed to maintain the temperature of PCM layer 222 within a desired range. Device 230 is configured to add heat to or remove heat from PCM layer 222 on command from controller 228, and may be of any suitable type such as, for example, a resistance-type heater configured to add heat, or a thermoelectric device configured to add and remove heat. Temperature sensor 226, controller 228, and heating/cooling device 230 each electrically communicate with, and receive power from, a power source 232. Power for source 232 may be derived from any suitable source including but not limited to, a DC battery, an alternator/generator operating in conjunction with an IC engine, an IC engine, an external AC outlet, a wind powered generator, or a solar-powered photovoltaic cell of any type. During operation, the temperature of PCM layer 222 may rise above or fall below the desired optimal operating range for battery 224. System 220 helps to keep battery 224 within its optimal temperature range by providing heating or cooling as necessary to PCM layer 222.

The various embodiments of the present invention described herein provide a temperature management system for a battery suitable for deployment in a vehicle. This system may be conveniently integrated into the structure of a typical battery and/or battery compartment in any of several ways including: 1) retention of a PCM in bulk within a jacket, or as an encapsulation within a retention layer in thermal communication with the outer walls of a battery or battery compartment, or by 2) encapsulation of the PCM within the outer wall itself of the battery or battery compartment. The PCM is formulated to have a melting temperature within the optimal operating temperature range of the battery, and has a relatively high latent heat of fusion. Accordingly, depending upon the surrounding temperatures, the PCM transitions between solid and liquid phases, absorbing or releasing heat as needed at a substantially constant melt temperature to stabilize battery temperature. In other embodiments, one or more layers comprising a PCM having a different composition and melting temperature may be added to provide further temperature stability. Further, the position of PCM-comprising layers relative to a battery may be adjusted as a function of temperature using shape memory materials. The temperature management system may also include supplemental heating/cooling/control elements configured to monitor the temperature of the PCM and add or remove heat as needed to provide further temperature stability.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention and the legal equivalents thereof.

What is claimed is:

1. A system for managing the temperature of a battery, the battery having a first outer surface, the system comprising:
a first reservoir coupled to the first outer surface of the battery; and
a first phase change material thermally coupled with the first outer surface of the battery and retained by the first reservoir.

2. A system according to claim 1, wherein the first reservoir comprises a jacket coupled to the first outer surface of the battery.

3. A system according to claim 1, wherein the first reservoir comprises a first encapsulation layer coupled to the first outer surface of the battery, the first encapsulation layer configured to encapsulate the first phase change material.

4. A system according to claim 1, wherein the first phase change material has a composition selected from a group consisting of crystalline alkyl hydrocarbons, paraffins, salt hydrates, poly-alcohols, and a combination thereof.

5. A system according to claim 1, wherein the first phase change material comprises a eutectic composition.

6. A system according to claim 1, wherein the first reservoir has a second outer surface, and further comprising:
a second reservoir coupled to the second outer surface of the first reservoir; and
a second phase change material thermally coupled to the second outer surface of first reservoir, and retained by the second reservoir.

7. A system according to claim 6, wherein the first phase change material has a first composition, and the second phase change material has a second composition different than the first composition.

8. A system according to claim 6, wherein the second reservoir comprises an encapsulation layer thermally coupled to the second outer surface of the first reservoir, the encapsulation layer configured to encapsulate the second phase change material.

9. A system according to claim 6, wherein the second reservoir comprises a jacket coupled to the second outer surface of the first reservoir.

10. A system according to claim 1, further comprising a heating system thermally coupled to the first phase change material, and configured to add heat thereto.

11. A system according to claim 1, further comprising a cooling system thermally coupled to the first phase change material, and configured to remove heat therefrom.

12. A system according to claim 1, further comprising a shape memory element coupled the reservoir, and configured to adjust the position of the reservoir relative to the first outer surface of the battery.

13. A battery comprising:
an outer wall; and
a first phase change material encapsulated within the outer wall.

14. A battery according to claim 13, wherein the outer wall has an outer surface, and further comprising:
a reservoir coupled to the outer surface of the outer wall; and
a second phase change material thermally coupled to the outer surface of the outer wall, and retained by the reservoir.

15. A battery according to claim 14, wherein the reservoir comprises a jacket.

16. A battery according to claim 14, wherein the reservoir comprises an encapsulation layer coupled to the outer surface of the outer wall, and configured to encapsulate the second phase change material.

17. A battery according to claim 14, wherein the first phase change material has a first composition, and the second phase change material has a second composition different than the first composition.

18. A battery assembly comprising:
a housing configured to contain a battery, the housing having a first wall; and
a first phase change material encapsulated within the first wall.

19. An assembly according to claim 18, further comprising:
a battery disposed within the housing, and having an outer wall;
a reservoir coupled to the outer wall; and
a second phase change material thermally coupled to the outer wall, and retained by the reservoir.

20. An assembly according to claim 18, further comprising:
a battery disposed within the housing and having an outer wall; and
a second phase change material encapsulated within the outer wall.
